(19) United States
(12) Patent Application Publication
(10) Pub. No.: US 2003/0089025 A1
(43) Pub. Date: May 15, 2003

(54) Rodent bait

(76) Inventors: Joe Maffo, Hilton Head, SC (US); David Forshee, Hilton Head, SC (US); Greg Forshee, Benzonia, MI (US)

Correspondence Address: Cohen & Grigsby, P.C., 15th Floor, 11 Stanwix Street, Pittsburgh, PA, 15222, US

(21) Appl. No.: 09/863,891

(22) Filed: May 23, 2001

Related U.S. Application Data
(60) Provisional application No. 60/206,388, filed on May 23, 2000.

(51) Int. Cl. A01M 1/20; A01M 25/00

(52) U.S. Cl. 43/131

(57) ABSTRACT

The present invention relates to an open structure for use with devices for controlling or capturing nuisance animals that comprises a plurality of elongated elements connected together with continuous ribs and an outwardly extending loop-portion that is disposed along one of the elongated elements and that has a substantially flat portion opposite to the elongated element that has a boss thereon.

### FIELD OF INVENTION

The present invention relates to a device for controlling nuisance animals and, in particular, to an open structure bait device designed for moveably adapting to a rodent trap and for luring and restraining rodents therein.

### BACKGROUND OF THE INVENTION

Generally, the open structure bait device of the present invention provides a bait for use with control devices for capturing and handling nuisance animals and critters. Nuisance control devices include, for example, traps that are live or lethal capture and other control equipment. Various rodenticide products and poisoned baits are also used to eliminate rodents. An important aspect of many control devices is determining the proper location for placing the trap and for positioning appropriate bait therein. Users of such traps often employ as bait common household foods such as cheeses, sweet-smelling fruits, vegetables or meats, for example, depending upon the type of nuisance animal. Other known baits include gland-based commercial lures and glue laid trap beds. However, these devices are not problem-free. Sometimes the bait becomes dislodged from the trap or nuisance animals and critters successfully devour the bait without triggering the trap. Other times the baited-trap may simply fail to attract a nuisance animal. Still other hassles and problems are known to be associated with common nuisance control devices.

Accordingly, it is an object of the present invention to overcome many disadvantages of the prior art control devices and to provide a device that securely attaches to a common rodent trap for attracting nuisance animals and critters and for placing them in a position to trigger the trap to ensure effective capture. It is a further objective of the present invention to provide a scented bait for luring the animals to the trap. These and other objects of the present invention will become apparent upon a perusal of the present disclosure.

### SUMMARY OF THE INVENTION

The present invention provides an open structure having a loop disposed thereon and shaped to interface with the common nuisance control device. Generally, the open structure is designed to accommodate the bite of the desired nuisance animal or critter. Preferably, the open structure takes the form of a cylindrical frame that has elongated elements connected with continuous ribs. More preferably the continuous ribs are annular ribs positioned relative to each other so that each end of each elongated element terminates into a rib and takes the form of a substantially cylindrical shaped frame.

In addition, an outwardly extending loop-portion is disposed along one of the elongated elements. The loop-portion has a side with a boss thereon for interfacing with a control device. Preferably, the side is a substantially flat portion opposite to the elongated element. The loop-portion of the open structure is designed to easily and moveably secure to a control device. For use of a preferred embodiment, for example, the loop-portion of the present invention easily slides over the tab or anchor that is provided on the common trap allowing the boss to interface with the tab thereby securing the present invention with the trap. Typically, these tabs or anchors are triangular or rectangular in shape and extend from the base, to reach above and substantially parallel thereto; although other styles are known and can be used with the present invention. In a preferred embodiment, the present invention is used in combination with a commercial rat trap by sliding the loop-portion of the structure over the tab provided on the base of a rat trap.

The distance between the intersections of elongated elements and ribs is designed according to the type and specification of the nuisance control device with which the invention will be used. Thus, the actual size of the open structure varies.

Preferably, the open structure of the present invention is manufactured by polypropylene extrusion process using molds designed to specification. If desired, during the manufacturing process a scent may be added to the open structure of the present invention for luring animals and critters. Of particular effectiveness are chocolate and peanut butter scents. These and other objects of the present invention will become apparent in the detailed description of preferred embodiment.

### BRIEF DESCRIPTION OF THE DRAWINGS

FIG. 1 is a cross sectional view of the open structure of the present invention.

FIG. 2 is a top plan view of the open structure of the present invention.

FIG. 3 is a vertical section of the open structure of the present invention that identifies the dimensions of a preferred embody.

FIG. 4 is a perspective of another embodiment of the present invention.

### DETAILED DESCRIPTION OF THE PREFERRED EMBODIMENTS

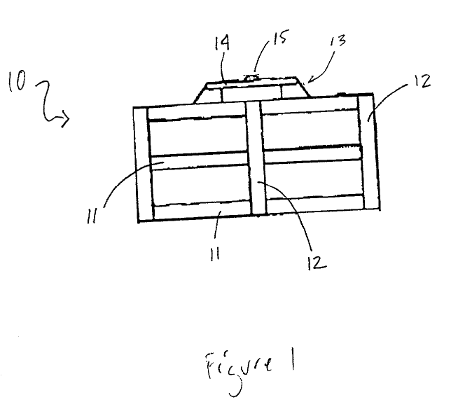

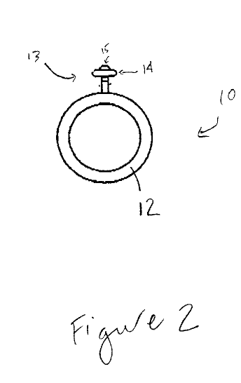

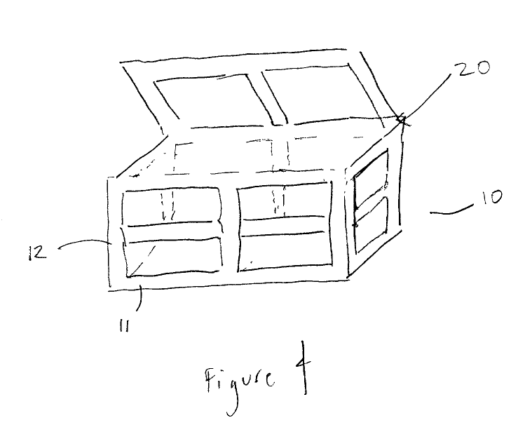

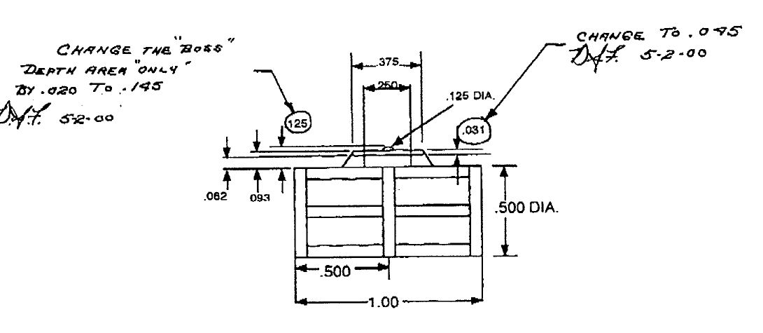

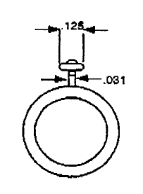

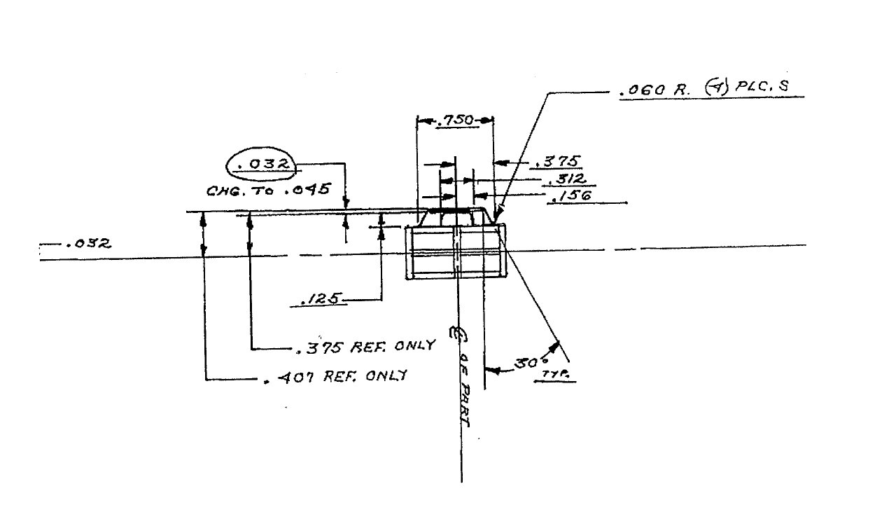

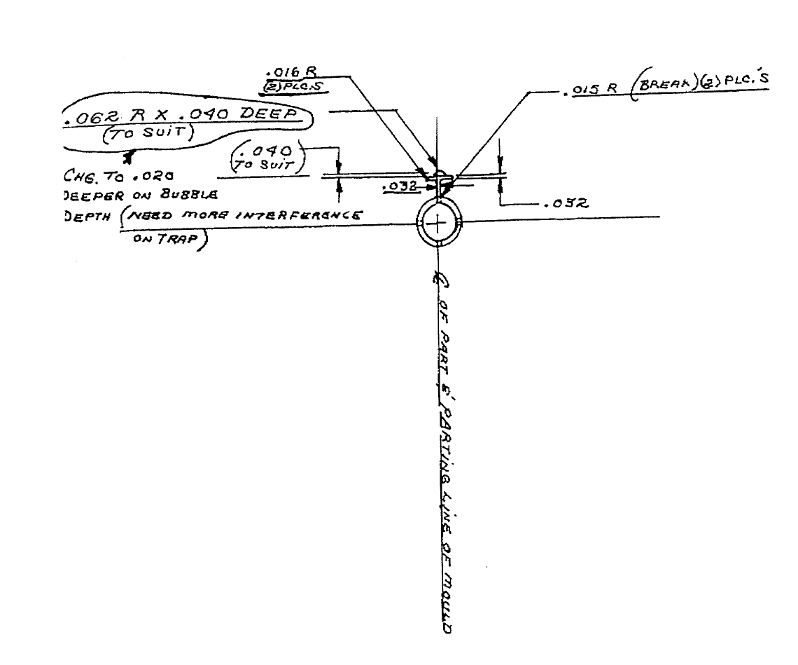

A preferred embodiment of the open structure of the present invention is substantially as shown in the drawing of FIG. 1. With reference to FIG. 1, the structure comprises an open structure or frame 10 having elongated elements 11 and ribs 12 connecting therewith. Preferably, elongated elements 11 are substantially the same length and have ends which terminate into ribs 12. More preferably, ribs 12 are continuous, annular ribs positioned equidistant relative to each other thereby taking the form of a substantially cylindrical shaped frame.

A loop-portion 13 is attached along at least one elongated element 11. Preferably, loop-portion 13 outwardly extends from the elongated element 11 in an opposite direction of frame 10 and easily and moveably adapts the structure for use with a common nuisance control device. The loop-portion 13 also has side 14. Side 14 further has boss 15 situated thereon for interfacing with a nuisance control device. In preferred embodiment, side 14 is substantially flat portion of loop-portion opposite to attached elongated element 11.

The loop-portion 13 of frame 10 is designed to easily and moveably secure to a control device. For example, when using the present invention with the common rodent trap, loop-portion 13 slides over the tab or anchor provided on the base of the trap. This allows the boss 15 to interface with the tab thereby securing frame 10 to the trap. The loop-portion of the present invention may be designed to accommodate tabs of varying lengths and shapes. Most commonly, tabs take on a triangular shape but are also rectangular.

The interconnection of elongated elements 11 with ribs 12 is designed to accommodate the bite of the desired nuisance animal or critter, or in accordance with the specifications of a particular nuisance control device. Thus, the actual size of the open structure varies depending upon the intended use of the invention. Preferably, elongated elements 11 have a length of about 0.5 to 1.5 inches and the ribs 12 have a diameter of about 0.25 to 0.5 inch and a thickness from about 0.030 to 0.060 inch. The size and shape of loop-portion 13 also varies depending on the specifications of the control device, and particularly the size and shape of the tab or anchor with which it moveably adapts. Preferably, loop-portion 13 has an opening there through with dimensions as measured from the frame 10 and a length at side 14 of 0.375 inches.

In a preferred embodiment of the present invention, an open structure, 10 similar to that shown in FIG. 1, is made of injection molded polypropylene with scent additives. The open structure comprises a plurality of elongated elements 11 that are connected together by annular, continuous ribs 12 to a substantially a cylindrical form. Each elongated element 11 has a length of about 1.0 inch, an annular rib 12 attached at the ends and a centered inner annular rib 12 positioned about 0.5 inch from both end ribs. The ribs 12 have a diameter of about 0.5 inch and have a thickness of about 0.03 inch. A loop-portion 13 is disposed along the frame 10 and affixed to one of elongated elements 11. Loop-portion 13 has a side 14 opposite to the affixing elongated element 11 and has an opening there through with a long dimension of about 0.250 inches and short dimension of about 0.031 inches. Side 14 is essentially a flat portion that is about 0.045 inches thick with a width of about 0.125 inches. Thereon is boss 15 that has diameter of about 0.125 inches. Loop portion 13 moveably attaches to a control device by inserting the tab or anchor part. Thereof through the opening of loop-portion 13.

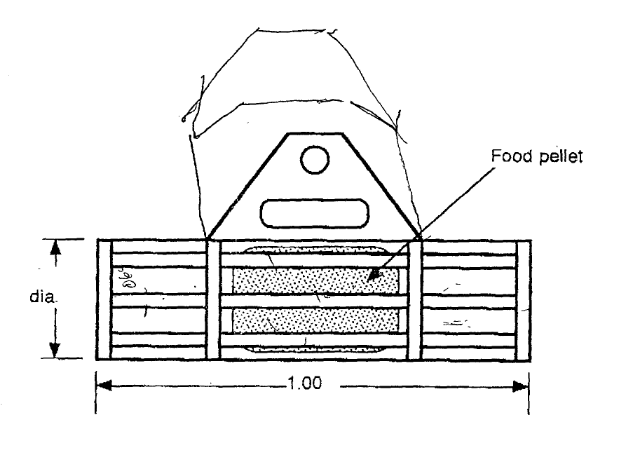

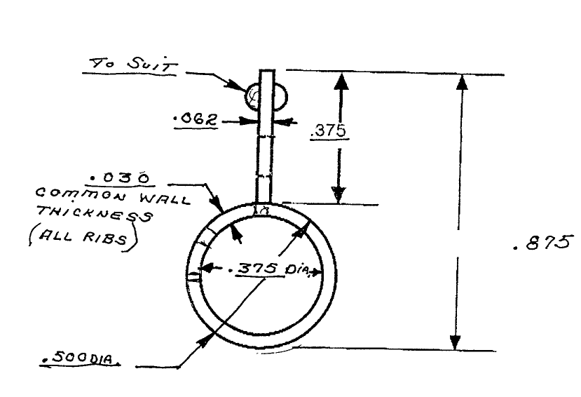

In another embodiment, substantially as shown in FIG. 4, open structure 10 comprises a plurality of elongated elements 11 that are connected together by discontinuous ribs 12 to substantially form the shape of an elongated box. One of the elongated elements 11 provides a pivot means 20 to allow at least one other elongated element, together with ribs 12 comprising a side of open structure 10, to move about the picot means to allow for the side to open and close with respect to open structure 10. Dimensions of the preferred embodiment are preferably 1.00 inch wide by 1.00 inch long. Additionally, loop-portion 13 attaches thereto and preferably is formed in the shape of an equidistant triangle. Other shapes may suitably be used for the design of open structure 10 and loop-portion 13.

What is claimed is:

1. An open structure for use with devices for controlling or capturing nuisance animals, comprising a plurality of elongated elements connected together with continuous ribs, and an outwardly extending loop-portion disposed along one of said elongated elements, said loop-portion having a substantially flat portion opposite to said elongated element said flat portion having a boss thereon.

2. An open structure as set forth in claim 1, wherein said elongated elements terminate into a rib at both ends.

3. An open structure as set forth in claim 1, wherein at least one rib is centrally disposed between two other ribs.

4. An open structure as set forth in claim 1 wherein said elongated elements and said ribs have a scent.

5. An open structure for removably attaching with a device for capturing rodents, comprising a plurality of elongated elements having substantially similar length and being connected with generally annular ribs, and an outwardly extending loop disposed along one of said elongated elements, and having a flat portion opposite to said elongated element said flat portion having a boss thereon.
